(19) United States
(12) Patent Application Publication
(10) Pub. No.: US 2024/0359314 A1
(43) Pub. Date: Oct. 31, 2024

(54) EXOSKELETON APPARATUS AND METHOD

(71) Applicant: FESTOOL GMBH, Wendlingen (DE)

(72) Inventors: Robert WEIDNER, Bohlsen (DE); Bernward OTTEN, Hamburg (DE)

(21) Appl. No.: 18/682,804

(22) PCT Filed: Aug. 12, 2022
(86) PCT No.: PCT/EP2022/072719

§ 371 Date: Feb. 9, 2024

(30) Foreign Application Priority Data
Aug. 13, 2021 (DE) 10 2021 208 900.3

(51) Int. Cl. B25J 9/00; B25J 9/16

(52) U.S. Cl. CPC B25J 9/0006; B25J 9/1694

(57) ABSTRACT

The invention relates to an exoskeleton device with a sensor device for detecting position information which indicates a position of an exoskeleton in relation to the environment, in particular in relation to gravity, and a control device for controlling an actuator device for providing a support force for a body part, wherein the control device is configured to adapt the provision of the support force on the basis of the detected position information and/or to adapt a shape of a base section and/or an attachment of the base section to the human body on the basis of the detected position information.

The invention relates to an exoskeleton device comprising an exoskeleton with a base section for attachment to a body section, in particular the torso, of a human body, a support section movably coupled to the base section for supporting a body part, preferably a limb, in particular an arm, of the human body, and an actuator device, in particular a pneumatic actuator device, acting on the support section for providing a support force for the body part.

The exoskeleton is worn on the human body and supports the musculoskeletal system in certain postures and movements. Preferred areas of application for the exoskeleton are manual and industrial applications in which the user is supported by the exoskeleton during repetitive activities in stressful postures. The user adopts different postures during these activities, for example different upper body positions, which can have an influence on the support provided by the exoskeleton.

Exoskeletons are known, for example, from WO2017157941A1, EP3266422A1, EP2754538B1 and US20150025423A1.

One object of the invention is to increase the operational safety and/or ease of use of the exoskeleton device.

The object is solved by an exoskeleton device according to claim 1. The exoskeleton device comprises a sensor device for detecting position information which indicates a position of the exoskeleton, in particular of the base section and/or of the support section, in relation to the environment, in particular in relation to gravity, and a control device for controlling the actuator device, the control device being configured to adapt the provision of the support force on the basis of the detected position information and/or to adapt, on the basis of the detected position information, the shape of the base section and/or the attachment of the base section to the human body.

By detecting and taking into account this position information, the exoskeleton can, for example, adjust the support force depending on the situation and/or posture and/or provide safety or comfort functions according to the user's upper body posture. By detecting the position information, the exoskeleton can recognize the user's upper body posture and adjust the support force behavior accordingly. In this way, user comfort can be increased when working with the exoskeleton. Furthermore, by detecting the position information, it is possible to recognize a dangerous situation, such as the user falling or tumbling. In this case, the exoskeleton can trigger a suitable action, such as switching off the support force and/or the exoskeleton.

The body part is preferably a limb of the human body. For example, the body part is an arm of the human body. Furthermore, the body part may be the back of the human body. In this case, the base section is expediently for attachment to a leg of the human body; i.e. the body portion (to which the base section is to be attached) may be, for example, a leg in the case where the body portion is the back.

Advantageous further developments are the subject of the subclaims.

The invention further relates to a method according to claim 15.

Further exemplary details and exemplary embodiments are explained below with reference to the figures. Thereby shows

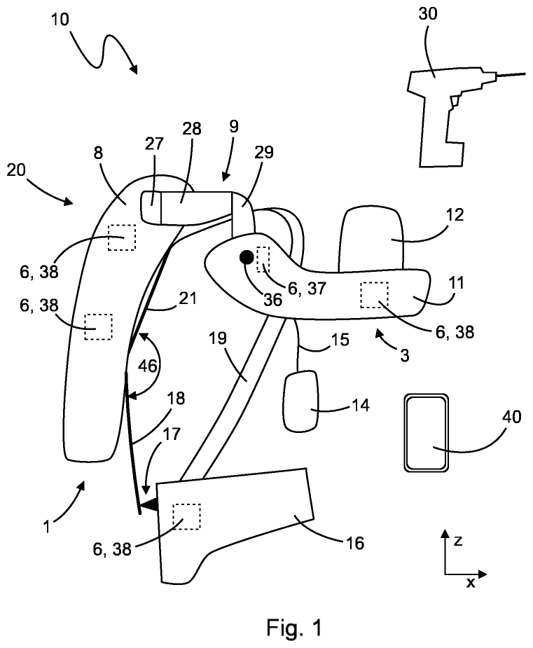

FIG. 1 a schematic side view of an exoskeleton device,

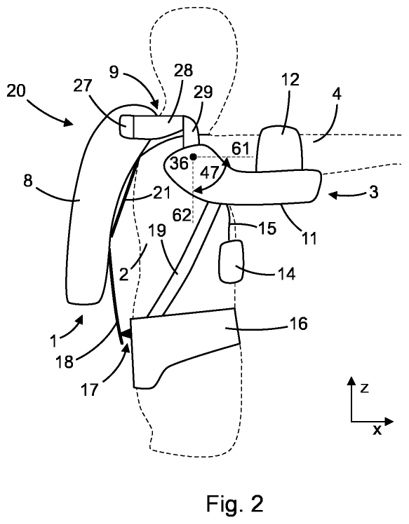

FIG. 2 a schematic side view of an exoskeleton worn by a user,

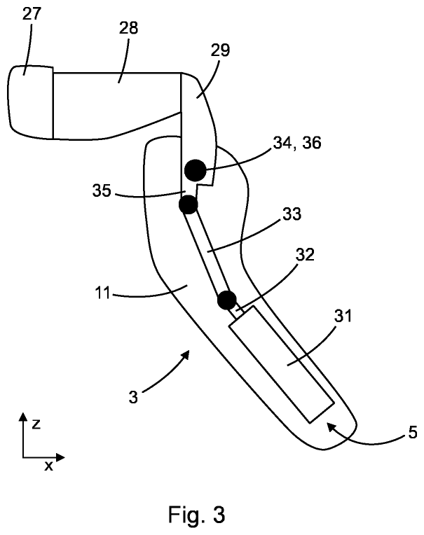

FIG. 3 a schematic detailed view of a support section of the exoskeleton,

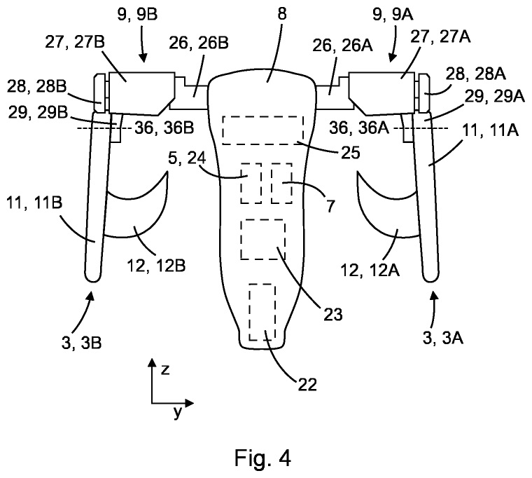

FIG. 4 a schematic rear view of the exoskeleton,

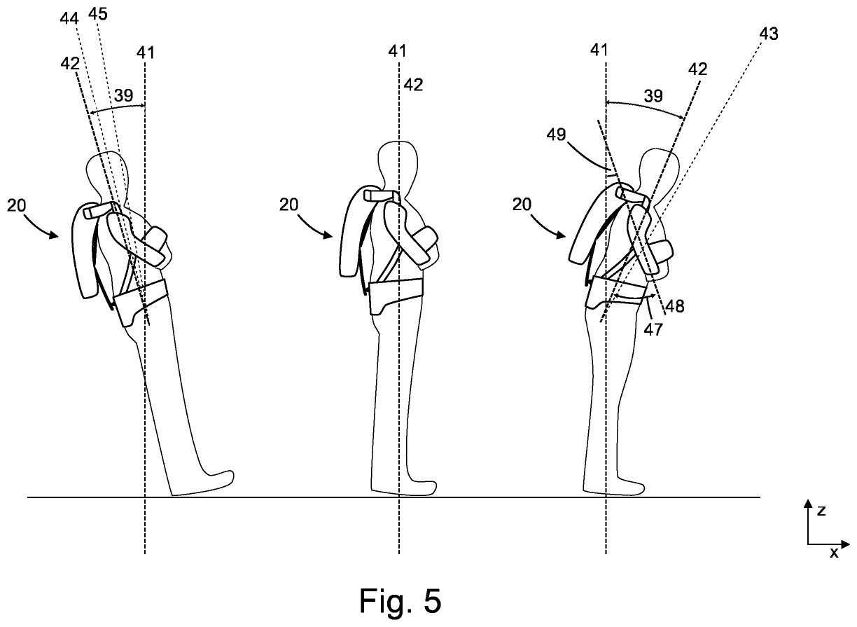

FIG. 5 different inclinations of the exoskeleton worn by the user, and

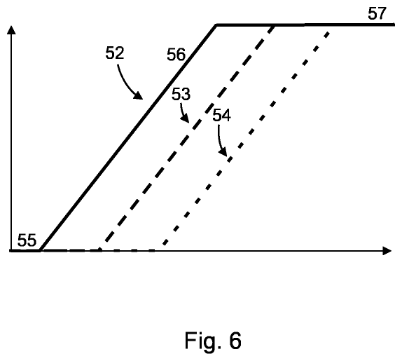

FIG. 6 shows a diagram with characteristic curves that relate a support force to an angle.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear-i.e. in particular the back of the user-to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a body part, preferably a limb, in particular an arm 4, of the human body of the user. In particular, the support section 3 is designed to be attached to the body part, preferably the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is inclined by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the body part, preferably the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the body part, preferably the limb, in particular the arm 4, of the user, in particular upwards, and thus provides the support force acting on the body part, preferably the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air-in particular the compressed air generated by the compressor 23.

The valve unit 24 expediently comprises one or more electrically operable valves and is designed in particular to influence a pneumatic connection from the compressed air tank to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

In the following, the detecting of position information mentioned at the beginning shall be discussed in more detail.

The sensor device 6 is configured to detect position information which indicates a position of the exoskeleton 20, in particular of the base section 1 and/or the support section 3, in relation to the environment, in particular in relation to gravity.

For example, the sensor device 6 comprises one or more position sensors 38 for detecting the position information. In particular, the sensor device 6 comprises as position sensor 38 an acceleration sensor and/or a gyroscope and/or an inertial measuring unit and/or a magnetometer and/or an optical sensor. One or more position sensors 38 can be arranged on the base section 1, in particular on the back part 8 and/or on the pelvic strap 16, and shall then be referred to as base section position sensors. Furthermore, one or more position sensors 38 can be arranged on the support section 3, in particular on the arm part 11, and shall then be referred to as support section position sensors.

In a preferred embodiment, the exoskeleton 20 comprises as position sensor 38 an acceleration sensor arranged on the arm part 11, an acceleration sensor arranged on the back part 8, a gyroscope arranged on the back part 8 and/or an acceleration sensor arranged on the pelvic strap 16.

Preferably, the exoskeleton 20 is configured to detect an inclination, in particular an angle of inclination 39, relative to the environment, in particular relative to gravity, as the position information by means of the sensor device 6, in particular the at least one position sensor 38.

Optionally, the exoskeleton device 10 can comprise one or more position sensors arranged separately from the exoskeleton 20 for detecting the position information. For example, a position sensor can be integrated in a belt or a vest.

In FIG. 5, the direction 41 of gravity is shown as a dashed line. The direction of gravity 41 runs parallel to the z-direction and/or is aligned in particular antiparallel and/or opposite to the z-direction. Furthermore, FIG. 5 shows a vertical alignment axis 42, in particular an imaginary vertical alignment axis 42, arranged in a fixed position relative to the exoskeleton 20, in particular the base section 1, preferably the back part 8. When the user wearing the exoskeleton 20 is standing upright, the alignment axis 42 is aligned vertically, in particular parallel to the direction of gravity 41. The alignment axis 42 is, for example, equal to the base section axis 62.

The angle of inclination 39 detected by the position sensor 38 is expediently the angle between the direction of gravity 41 and the alignment axis 42.

The inclination angle 39 detected by the sensor device 6 expediently indicates the inclination of the user's torso 2—i.e. in particular the user's upper body posture. A forward inclination-for example, when the user's upper body is bent forward, as shown on the right in FIG. 5-shall be described as a positive inclination and results in a positive inclination angle 39. A backward inclination-for example, when the user's upper body is bent backward, as shown on the left in FIG. 5-shall be described as a negative inclination and results in a negative inclination angle 39. If the alignment axis 42 is aligned parallel to the direction of gravity, the inclination angle 39 is zero.

Optionally, the sensor device 6 can have an optical sensor, in particular an image sensor, and the control device 7 can be configured to determine the position information, in particular the angle of inclination 39, on the basis of optical sensor data recorded by the optical sensor, for example by the control device 7 recognizing markers in the sensor data and inferring the position information based on a detected position and/or orientation of the markers.

According to one possible embodiment, the control device 7 is configured to detect an angle of the support section 3, in particular the longitudinal axis 48 of the support section 3, relative to the direction of gravity 41 as the position information. This angle shall also be referred to as the support section absolute angle 49. Preferably, the control device 7 detects the support section absolute angle 49 directly, in particular by means of a support section position sensor designed, for example, as an acceleration sensor. Furthermore, the control device 7 can detect the support section absolute angle 49 indirectly, namely by the control device 7 detecting the pivot angle 47 of the support section 3 relative to the base section 1 and the inclination angle 39 of the base section 1 relative to the direction of gravity 41 and calculating the support section absolute angle 49 on the basis of the pivot angle 47 and the inclination angle 39, in particular as the difference between the pivot angle 47 and the inclination angle 39.

The longitudinal axis 48 of the support section 3 is, for example, the same as or parallel to the support section axis 61.

According to a preferred embodiment, the exoskeleton 20 comprises a support section position sensor arranged on the support section 3, which support section position sensor is designed in particular as an acceleration sensor, and the control device 7 is configured to use the support section position sensor to detect the position information, in particular the angle of inclination 39 of the base section 1, in particular of the back part 8, relative to gravity. Preferably, the control device 7 is configured to take into account an angle—for example the pivot angle 47—between the base section 1 and the support section 3 when detecting the position information.

For example, the control device 7 uses the angle sensor 37 to detect the pivot angle 47 of the support section 3 relative to the base section 1 and the support section position sensor to detect the support section absolute angle 49 of the support section 3 relative to gravity and uses the pivot angle 47 and the support section absolute angle 49 to calculate the inclination angle 39 of the base section 1 relative to gravity as the position information.

The following section describes in more detail how the position information can be used.

The control device 7 is configured to adjust the provision of the support force on the basis of the detected position information and/or to adjust, on the basis of the detected position information, the shape of the base section 1 and/or the attachment of the base section 1 to the user.

Firstly, regarding the adjustment of the support force:

According to a preferred embodiment, the control device 7 is configured to adapt the provision of the support force on the basis of the detected position information in such a way that the influence of an inclination of the base section 1 relative to the environment, in particular relative to gravity, on the support force is compensated.

In particular, the control device 7 is configured to apply a smaller support force in response to a detected position information indicating a greater inclination of the base section 1 relative to the environment, in particular to gravity, than in response to a detected second position information indicating a smaller inclination of the base section, in particular with the same angle of the support section 3 relative to the base section 1.

For example, in response to detected first position information indicating a first inclination of the base section 1 relative to the environment, in particular to gravity, the control device 7 causes a first support force and, in response to detected second position information indicating a second inclination of the base section, causes a second support force, in particular at the same pivot angle 47 of the support section relative to the base section. The first inclination is greater than the second inclination and the first support force is less than the second support force. In particular, the control device 7 causes the support force to decrease as the angle of inclination 39 increases (at a constant pivot angle 47).

The control device 7 expediently adjusts the support force depending on the pivot angle 47, in particular in such a way that the support force in at least a first pivot angle range increases with increasing pivot angle 47. For example, the support force should be minimal, for example equal to zero, when the user's arm is pointing vertically downwards.

If the user bends his upper body and thus the base section 1 forwards and continues to keep his arm pointing vertically downwards, the pivot angle 47 increases, which would, without compensation measures, lead to an increase in the support force due to the dependence of the support force on the pivot angle 47. The control device 7 recognizes from the position information that the base section 1 is inclined forwards and compensates for this influence of the inclination of the base section 1 (and the resulting increased pivot angle 47) on the calculation of the support force by the control device 7 reducing the support force specified by the pivot angle 47 in accordance with the inclination of the base section 1-i.e. in accordance with the inclination angle 39. In particular, the control device 7 performs the compensation on the basis of the inclination angle 39 in such a way that, when the arm 4 is aligned vertically downwards and the base section 1 is inclined forwards, the support force is minimal, in particular equal to zero, for each inclination angle 39.

Preferably, the control device 7 performs the compensation on the basis of the inclination angle 39 in such a way that the support force is minimal, in particular equal to zero, for an arm 4 aligned downwards within a predetermined angular range and with the base section 1 inclined forwards, in particular for each inclination angle 39. The predetermined angular range expediently extends from minus 10 degrees to plus 10 degrees with respect to the gravity direction 41 or from minus 20 degrees to plus 20 degrees with respect to the gravity direction 41.

In particular, the control device 7 corrects the support force—i.e. the force support of one or both arms—according to the detected body posture-namely the position information, in particular the inclination angle 39.

According to a preferred embodiment, the control device 7 controls the support force in such a way that the support force is independent of the inclination of the base section 1—i.e. independent of the inclination angle 39—and in particular dependent on the support section absolute angle 49. For example, the control device 7 sets the support force on the basis of the support section absolute angle 49.

Expediently, the support force is set in such a way that arms hanging vertically downwards, in particular pointing vertically downwards, do not experience any support force, regardless of the torso inclination.

According to a preferred embodiment, the control device 7 is configured to set the support force according to a characteristic curve 52, which defines the support force as a function of an angle—in particular the pivot angle 47—between the base section 1 and the support section 3. The control device 7 is configured to scale the characteristic curve 52 on the basis of the detected position information and/or to shift it in relation to the angle. Furthermore, the control device 7 is configured to set the support force in accordance with the scaled and/or shifted characteristic curve.

FIG. 6 shows a diagram with an exemplary characteristic curve 52 together with a first shifted characteristic curve 53 and a second shifted characteristic curve 54. The pivot angle 47 is plotted on the horizontal axis and the support force is plotted on the vertical axis. The characteristic curve 52 comprises (in particular in the direction of the increasing pivot angle 47) a first characteristic curve section 55, a second characteristic curve section 56 adjoining the first characteristic curve section 55 and a third characteristic curve section 57 adjoining the second characteristic curve section 56. As an example, the first characteristic curve section 55 is constant, in particular equal to zero, the second characteristic curve section 56 is increasing, in particular linearly increasing, and the third characteristic curve section 57 is constant, in particular greater than zero. According to the characteristic curve 52, the support force is therefore initially constant at zero as the pivot angle 47 increases, then increases linearly and then remains at a constant value greater than zero.

The control device 7 is preferably designed to shift the characteristic curve 52 in relation to the pivot angle 47—i.e. in the direction of the horizontal axis—on the basis of the inclination angle 39. For example, the control device 7 shifts the characteristic curve 52 by the inclination angle 39 in the direction of the increasing pivot angle 47. As an example, the control device 7 shifts the characteristic curve 52 at a first inclination angle 39 in the direction of the increasing pivot angle 47 by the first inclination angle 39 in order to obtain the first shifted characteristic curve 53. Furthermore, the control device 7 shifts the characteristic curve 52 at a second inclination angle 39 in the direction of the increasing pivot angle 47 by the second inclination angle 39 in order to obtain the second shifted characteristic curve 53. As an example, the second inclination angle 39 is greater than the first inclination angle 39 and the second characteristic curve section of the first shifted characteristic curve 53 lies in the direction of the horizontal axis of the diagram between the second characteristic curve section 56 of the characteristic curve 52 and the second characteristic curve section of the second shifted characteristic curve 54.

According to an optional embodiment, the control device 7 is configured to set the support force according to a characteristic curve 52, which defines the support force as a function of an angle—in particular the support section absolute angle 49—between the direction of gravity 41 and the support section 3.

According to a preferred embodiment, the control device 7 is configured to cause a reduction and/or deactivation of the support force in response to the detected position information indicating an inclination of the base section 1 relative to the environment, in particular to gravity, which exceeds or falls below an inclination threshold value.

Exemplary inclination threshold values are shown in FIG. 5. By way of example, the control device 7 compares the inclination angle 39 with a first inclination threshold value 43, which indicates a forward inclination and is positive in particular, and causes the reduction and/or deactivation of the support force in response to the fact that the inclination angle 39 exceeds the first inclination threshold value 43. The first inclination threshold 43 is 50°, for example. By way of example, the control device 7 compares the inclination angle 39 with a second inclination threshold value 44, which indicates a rearward inclination and is in particular negative, and causes the reduction and/or deactivation of the assistance force in response to the inclination angle 39 falling below the second inclination threshold value 44. The second inclination threshold 44 is, for example, −30°. Expediently, the first inclination threshold value 43 and the second inclination threshold value 44 differ in their amount. Expediently, the amount of the first inclination threshold value 43 is greater than that of the second inclination threshold value 44.

Preferably, the control device 7 is configured to cause, in response to the fact that the detected position information indicates an inclination of the base section 1 relative to the environment, in particular to gravity, which exceeds and/or falls below an inclination threshold value and/or is close to the inclination threshold value, an output of a warning signal which can be perceived by the user of the exoskeleton device 10.

For example, the control device 7 compares the inclination angle 39 with a warning inclination threshold value 45 and causes the warning signal to be output if the inclination angle 39 exceeds or falls below the warning inclination threshold value 45. In the example shown, the warning inclination threshold value 45 is defined for a rearward inclination and is correspondingly negative, for example −20°. Alternatively or additionally, a warning inclination threshold value can be defined for a forward inclination. The warning inclination threshold value 45 is expediently smaller in amount than the first inclination threshold value 43 and/or the second inclination threshold value 44.

The exoskeleton device 10, for example the exoskeleton 20 and/or the mobile device 40, has an output device controlled by the control device 7 to output the warning signal. For example, the warning signal is provided by the actuator device 5, in particular the drive cylinder 31, for example as a vibration.

The warning signal is, for example, an optical, acoustic and/or tactile signal. The control device 7 is expediently designed to increase the intensity of the warning signal as the inclination angle 39 approaches an inclination threshold value. The intensity is increased, for example, by an increasingly faster warning tone, increasingly faster flashing of a warning light in the user's field of vision and/or increasingly stronger vibration of the support section 3.

As an example, the control device 7 is configured to successively reduce the support force as the inclination angle 39 approaches an inclination threshold value. For example, the exoskeleton 20 initially displays a visual, acoustic and/or tactile warning when approaching the second inclination threshold value 44 when the upper body is reclined, successively reduces the support force when approaching it further and escalates the visual, acoustic and/or tactile warning before the exoskeleton 20 switches off the support force completely when falling below the second inclination threshold value when the upper body is reclined. For example, the support force is reduced linearly until it is switched off.

According to a preferred embodiment, the control device 7 is configured to detect an emergency situation, for example a free fall, in particular of the user, on the basis of the detected position information.

For example, the position information indicates an acceleration of the exoskeleton. The control device 7 is expdiently designed to compare the position information, in particular a detected acceleration, with an emergency situation threshold value and to detect the emergency situation when the emergency situation threshold value is reached.

In particular, the control device 7 is configured to trigger an emergency response in response to the detected emergency situation, in particular deactivation of the support force and/or deactivation of the tool 30 and/or sending an emergency call, in particular by means of the mobile device 40, and/or ejection of the exoskeleton 20 from the user.

Preferably, the emergency situation is detected by means of a sensor worn by the user, in particular a (multi-axis) acceleration sensor, and in response to the detected emergency situation, a control software (which is executed, for example, on the control device 7) sets the devices used by the user—in particular the exoskeleton 20, the tool 30 and/or the mobile device 40) to an emergency response mode.

According to a preferred embodiment, the control device 7 has at least two manually and/or automatically selectable presets, each of which has at least one preset characteristic that defines a support force specification as a function of at least one input variable, in particular the detected position and/or the pivot angle 47, whereby the at least two presets differ in their preset characteristic. The control device 7 is configured to use a preset selected from the at least two presets to determine the support force specification as a function of the input variable and to set the support force on the basis of the support force specification. The presets can also be referred to as application profiles and the preset characteristics can also be referred to as application profile characteristics.

Preferably, the control device is configured to select the preset from the at least two presets on the basis of the detected position information. For example, the control device 7 can automatically activate a preset on the basis of an upper body posture (detected according to the position information).

Expediently, a preset can be created and/or configured by the user, in particular by means of the mobile device 40. For example, a preset comprises working range information that defines the range of the inclination angle 39 in which the support force is to be provided. For example, an overhead work preset is provided which contains the working range information that no support force is to be provided from a first predetermined positive inclination angle 39, i.e. from a first predetermined upper body position. Expediently, a load-lifting preset is present that contains the working range information that the support force should still be provided at the first predetermined positive inclination angle 39. Different presets therefore expediently define different ranges of the inclination angle 39 in which ranges the support force is to be provided. Within the working ranges in which the support force is provided, the presets expediently define a dependency between the support force and the pivot angle 47.

Preferably, via the exoskeleton device 10, in particular via the mobile device 40, an adaptation of a characteristic curve that defines the support force as a function of the pivot angle 47, can be configured as a function of the inclination angle 39 and can be stored as part of a preset.

In the following, it will be discussed in more detail how, on the basis of the position information, the shape of the base section 1 and/or the attachment of the base section 1 to the human body can be adapted.

According to a preferred embodiment, the base section 1 has a back element. As an example, the back element is formed by the back part 8 and the force transmission element 18. The control device 7 is configured to adjust the stiffness, length and/or position of the back element on the basis of the detected position information.

For example, the exoskeleton 20 is designed to adapt the force transmission element angle 46 on the basis of the position information, in particular in such a way that the force transmission element angle 46 is reduced with a larger inclination angle 39, in particular by rotational movement of the force transmission element 18 about the adjustment axis relative to the back part 8. In this way, the shape of the base section 1 can be adapted to the user's posture.

Preferably, the exoskeleton 20 is designed to adapt the bending stiffness of the back element based on the position information, in particular about a bending axis running parallel to the y-direction.

For example, the exoskeleton 20 adjusts the stiffness of the force transmission element 18 depending on the upper body angle (indicated by the position information), in particular in such a way that the force transmission element 18 has a higher stiffness when the user is in an upright position than when the user is bent forward.

For example, the exoskeleton 20 is designed to adapt the length, in particular the vertical extension, of the back element on the basis of the position information, in particular by translational movement of the force transmission element 18 relative to the back part 8.

According to a preferred embodiment, the base section has a fastening strap, in particular the pelvic strap 16, and the control device 7 is designed to vary the tension of the fastening strap, in particular to tighten or relax it, on the basis of the detected position information. For example, the tension of the user's pelvic strap 16 is reduced when the user bends forward and is tightened again when the user assumes an upright posture again.

Preferably, the exoskeleton 20 comprises one or more electrical and/or pneumatic actuators controlled by the control device 7, for example a back element actuator and/or a pelvic strap actuator, for making one or more of the aforementioned adjustments.

1. An exoskeleton device, comprising:
an exoskeleton:
a base section for attachment to a body section of a human body,
a support section movably coupled to the base section for supporting a body part of the human body,
an actuator device acting on the support section for providing a support force for the body part,
wherein the exoskeleton device further comprises:
a sensor device for detecting position information which indicates a position of the exoskeleton in relation to the environment and
a control device for controlling the actuator device, wherein the control device is configured to adapt the provision of the support force on the basis of the detected position information and/or to adapt, on the basis of the detected position information, the shape of the base section and/or the attachment of the base section.

2. The exoskeleton device according to claim 1, wherein the control device is configured to adapt the provision of the support force on the basis of the detected position information in such a way that the influence of an inclination of the base section relative to the environment on the support force is compensated.

3. The exoskeleton device according to claim 1, wherein the control device is configured to effect a smaller support force in response to detected position information indicating a greater inclination of the base section than in response to detected position information indicating a smaller inclination of the base section, in particular at the same angle of the support section relative to the base section.

4. The exoskeleton device according to claim 1, wherein the control device is configured to cause a reduction and/or deactivation of the support force in response to the detected position information indicating an inclination of the base section relative to the environment which exceeds or falls below an inclination threshold value.

5. The exoskeleton device according to claim 1, wherein the control device is configured, in response to the detected position information indicating an inclination of the base section relative to the environment which exceeds and/or falls below an inclination threshold value and/or is close to the inclination threshold value, to cause an output of a warning signal which is perceivable by the user of the exoskeleton device.

6. The exoskeleton device according to claim 1, wherein the control device is configured to detect an emergency situation on the basis of the detected position information.

7. The exoskeleton device according to claim 6, wherein the control device is configured to effect an emergency reaction in response to the detected emergency situation.

8. The exoskeleton device according to claim 1, wherein the sensor device has a support section sensor element attached to the support section, and the control device is configured to detect the position information with the support section sensor element.

9. The exoskeleton device according to claim 1, wherein the control device is configured to take into account an angle between the base section and the support section when detecting the position information.

10. The exoskeleton device according to claim 1, wherein the control device is configured to set the support force according to a characteristic curve which defines the support force as a function of an angle between the base section and the support section, and the control device is further configured to scale the characteristic curve on the basis of the detected position information and/or to shift the characteristic curve with respect to the angle.

11. The exoskeleton device according to claim 1, wherein the base section has a back element and the control device is designed to adjust a stiffness, length and/or position of the back element on the basis of the detected position information.

12. The exoskeleton device according to claim 1, wherein the base section has a fastening strap and the control device is configured to vary the tension of the fastening strap on the basis of the detected position information.

13. The exoskeleton device according to claim 1, wherein the control device has at least two manually and/or automatically selectable presets which each have at least one preset characteristic which defines a support force specification as a function of at least one input variable, wherein the at least two presets differ in their preset characteristics, and wherein the control device is configured to determine, using a preset selected from the at least two presets, the support force specification as a function of the input variable and to set the support force on the basis of the support force preset.

14. The exoskeleton device according to claim 13, wherein the control device is configured to select the preset from the at least two presets on the basis of the detected position information.

15. A method of operating an exoskeleton device according to claim 1, comprising the steps of:
detecting the position information,
based on the detected position information, adjusting the support force and/or adjusting the shape and/or attachment of the base section.

16. The exoskeleton according to claim 1, wherein the base section serves for attachment to the torso of a human body and the support section serves for supporting an arm of the human body.

17. The exoskeleton according to claim 1, wherein the position information indicates a position of the base section and/or the support section in relation to gravity.

18. The exoskeleton according to claim 6, wherein the emergency situation is a free fall.

19. The exoskeleton device according to claim 7, wherein the emergency reaction comprises a deactivation of the support force and/or a deactivation of a tool and/or the sending of an emergency call and/or a jettisoning of the exoskeleton from the user.

20. The exoskeleton according to claim 8, wherein the support section sensor element is an acceleration sensor.
